(19) United States
(12) Patent Application Publication
(10) Pub. No.: US 2004/0085716 A1
(43) Pub. Date: May 6, 2004

(54) Modular keyboard system

(76) Inventor: Alan K. Uke, Del Mar, CA (US)

Correspondence Address: KENNETH J. COOL, BLAKELY, SOKOLOFF, TAYLOR & ZAFMAN, 12400 WILSHIRE BOULEVARD, SEVENTH FLOOR, LOS ANGELES, CA, 90025, US

(21) Appl. No.: 10/290,102

(22) Filed: Nov. 5, 2002

(51) Int. Cl. G06F 1/16

(52) U.S. Cl. 361/680; 400/82

(57) ABSTRACT

The present invention provides a modular, openable keyboard that provides convenient replacement or substitution of various keyboard components, such as upper housing pieces, keystroke resistance setting components, key sets, liquid resistance barriers, and storage areas. Also described are kits for customizing or modifying the modular keyboards, and methods involving modifying the keyboards.

### FIELD OF THE INVENTION

The present invention relates to keyboards for computers, electric typewriters and other manual data input devices.

### BACKGROUND OF THE INVENTION

Conventional keyboards for computers, typewriters, or similar machines typically have a set of keys. The standard key arrangement for alphanumeric keyboards used by a majority of keyboard manufacturers throughout the world has at least three parallel rows of ten or more keys. The keys of one row are staggered relative to the keys of an adjacent row. The keys typically including the twenty-six letter keys arranged in the standard QWERTY format and four punctuation keys. In addition to the alphabetic keys, conventional keyboards specifically designed for use with computers also have numeric keys and function keys, which typically are located above, below, or on one or both sides of the alphabetic keys. The function keys typically include, for example, the tab, shift, and return keys as well as the alt, control, and option keys.

Typically computer keyboards have two-piece housings, with an upper housing piece and a lower housing piece, which are held together by 4-12 screws. Repairing or replacing parts of the keyboard generally require disassembling the keyboard by removing the multiple screws and separating the upper and lower housing pieces. As the screws are held by molded plastic, generally the threads will only tolerate a few openings before stripping. Thus, once keyboards are assembled, they are usually used as provided, and are not modified to fit particular users or particular applications.

In addition to not allowing convenient modification, keyboards are generally supplied in a very limited range of variations. For computer keyboards, the keyboard housing is usually a shade of beige, though occasionally black or a shade of gray is used, and the surface usually has a smooth to slightly roughened texture.

### SUMMARY OF THE INVENTION

The present invention provides an openable keyboard that allows customization of aesthetic, ergonomic, and/or functional characteristics by convenient, modular replacement of the corresponding keyboard components. While a number of different components can be replaced, either singly or in combination, exemplary components that can be replaced include the exterior components of the keyboard. These include the keyboard housing top or a top overlay, housing bottom, keys or key covers, and external storage areas. Replacement of one or more of these components provides a person with advantages such as the ability to alter the appearance of the keyboard to personal preferences, alter the upper surface to include a hand support area or other features, incorporate differing key sets (e.g., adapted for a particular language), and add storage areas for computer disks and the like. Thus, keyboard housing pieces can be selected that differ in many different ways from “standard” keyboards, including such characteristics as color, texture, pattern, shape, and key sets.

In addition to the housing pieces and keys, other keyboard components can also be replaced. These include, for example, keystroke resistance setting members and liquid resistant barriers. Replacement of the resistance setting members allows the user to obtain ergonomic properties better adapted to the individual, which can help prevent and/or alleviate injury to the forearms, wrists and/or hands of that individual. Insertion of a liquid resistant barrier provides protection for the keyboard against liquids, e.g., in environments where liquid spills may occur.

Such customization or modification is not limited to modification by the end user. For example, the convenient replacement of various components also allows customization by others, such as by a manufacturer, distributor, wholesaler, retailer, or business providing the keyboards for use by employees.

Thus, in a first aspect, the present invention provides a modular, openable keyboard in which any one or more of the following are configured to be replaceable: the top housing piece (or member) or a top overlay, the bottom housing piece (or member), keystroke resistance setting members, liquid resistant barrier, and storage areas. Such keyboards include a plurality of keys, typically accessible through the upper housing, i.e., the keys protrude through an opening or openings in the upper housing of the keyboard such that they can be depressed by a user. The top and bottom of the keyboard are held together with one or more releasable couplings.

As used in connection with the present keyboards, the term “openable” indicates that the keyboard can be separated into 2 or more parts (e.g., a top piece and a bottom piece) such that a top housing piece and/or internal components and/or bottom housing piece can be replaced. Such separation can be accomplished without requiring removal of more than 2 housing screws, and preferably not more than 2 housing screws total, and/or the screws and corresponding female threads of the screw receptacle are “durable”, meaning that screws and female threads are used such that the screws can be removed and replaced in a normal manner (i.e., without taking special precautions) at least 5 times, preferably at least 10, 20, 40, or more times, without damage to either the male or female threads. Preferably removal of no more than 1 screw is needed, or even no screws. The separation may be by opening along one side, with the other side being hinged, or the top and/or bottom of the keyboard can be fully separated, e.g., using a hinge that allows separation at the hinge when the hinged pieces have been rotated sufficiently with respect to each other, or by separation of unhinged top and bottom pieces.

The term “releasable” in connection with a fastener or coupling means that the fastener or coupling can be unfastened without damaging the fastener or the component(s) that are held. Highly preferably, the coupling is designed to be, and can be, operated with requirement for any tools, such as a screwdriver, though some couplings, such as some twist-lock fasteners, may be designed to be operated using a non-tool object such as a coin. The coupling can also be refastened without damage. Preferably, with normal use, the unfastening and refastening can be repeated at least 3, 5, 10, 20, or 50 times, or even more, without significantly degrading the holding power of the fastener or significantly damaging the components being held.

In the context of the present keyboards, the terms “interchangeable” and “replaceable” indicate that the specified components can replace each other without modification to those components or to other components of a keyboard on which they are to be installed.

A variety of replaceable tops and/or overlays and/or bottoms for the modular keyboard can be provided. These can include, for example, colored, patterned, and/or textured keyboard components. Thus, the keyboard visual properties can, for example, match the surrounding environment, or reflect the individual taste of the user. A replaceable top can also provide a hand rest area for a keyboard that previously lacked such an area. Likewise, keys or key caps can be replaced, e.g., to match the keyboard top. A replacement upper housing piece or overlay can also provide advantageous additional or altered function, e.g., by providing alternate key layout information, such as a layout for a language utilizing at least some different characters than English or other standard for which the keyboard was originally designed. Likewise, a different key layout can be provided, e.g., to provide keys for characters that are not represented in English, utilizing switch positions that are present in the switch template or other switch set but not utilized in a “standard” keyboard. Thus, a replacement upper housing piece may accommodate more or fewer keys than in a “standard” keyboard or in a prior configuration of the same keyboard. A plurality of different (e.g., visually different), interchangeable upper housings can be provided.

The upper housings can also be provided together with one or more other components, such as lower housings, key caps or keys, keystroke resistance setting members, liquid resistant barriers, storage areas and/or instructions.

Likewise, a plurality of different keystroke resistance setting members can be provided, with each of the resistance setting members configured to be replaceably positioned within the openable keyboard. Each resistance setting member is structured to produce a different keystroke resistance for the plurality of keys. Typically, the resistance setting members are provided as a single unit, e.g., as a template or diaphragm, which can also be attached to, or formed as an integral part of the switch set. As described for the upper housings, such keystroke resistance setting members, preferably diaphragms, can be provided together with one or more keyboards, separately, or as part of a kit (such as a kit that includes at least one keyboard and/or instructions for installing or replacing the keystroke resistance setting members.)

In certain embodiments, the modular keyboard is provided with storage compartments sized to receive data storage devices, such as compact discs, digital versatile disks, floppy disks, flash memory cards and other data storage devices. Such storage areas can be integrated in the lower or upper keyboard housing, or can be replaceable storage areas that attach to the housing.

Still further, a liquid resistant barrier can be provided that can be inserted under the keys and above a circuit board(s) and/or other electronic components to protect such electronic components in the keyboard from contact with spilled liquids.

The design of the present keyboards to be openable and to allow convenient replacement of upper housing pieces allows provision of sets of different housing tops for an openable keyboard of a pre-selected design. Corresponding different keys or key cap sets can also be provided. Similarly, the invention provides sets of resistance setting members with different key stroke properties, e.g., key stroke distance and/or key stroke resistance, for a pre-selected keyboard design. Members in such sets of different housing tops can, for example, differ in color, pattern, texture, perimeter shape, number of keys, positioning of keys, and/or selection or presence of an image or text on the housing. Likewise, key caps can, for example, differ in color, pattern, texture, number of keys, and in the symbols or other identification on the upper surfaces of the key caps.

In connection with the present keyboards, the term “design” is used such that two keyboards of the same design will have interchangeable components without structural modification, e.g., without cutting, shaping, or adding fastener locations. Thus, in connection with the provision of a component or a set of components, a “pre-selected design” is one that is selected prior to or contemporaneous with the selection of a replacement component or set of components.

Similarly, the availability of a plurality of different replaceable upper housing pieces, keys or key caps, lower housing pieces, resistance setting members, and liquid resistance barriers also provides kits for making or modifying a computer keyboard. Such a kit includes at least one replaceable component selected from an upper housing piece, a lower housing piece, a resistance setting member, a liquid resistance barrier, and a storage area. Expressly included is each sub-combination of the listed replaceable components. Examples include, but are not limited to kits containing the following combinations; upper and lower housing pieces, with or without replacement key sets; upper housing piece with key set; upper housing piece, key set, and resistance setting members; and lower housing piece and storage area. Kits can also contain a plurality of different upper and/or lower housing pieces, resistance setting members, key or key cap sets, liquid resistant barrier, and/or storage areas.

The ability to interchange housing pieces and key sets further provides a method for enabling modification or customization of a keyboard or set of keyboards of a selected design, by providing a keyboard or plurality of keyboards of one design, which may have the top housing piece and/or key set present or absent, and a set of different upper housing pieces and/or key sets and/or resistance setting members and/or storage areas configured to fit that design. Preferably the set of upper housing pieces and/or key sets are selected by a retailer, a wholesaler or distributor, or a retail customer. A further method for modifying or customizing a keyboard or set of keyboards involves installing or replacing the upper housing and/or one or more of the other replaceable components listed above. In particular, a method for adjusting keystroke resistance of a plurality of keys in an openable keyboard involves replacing a keystroke resistance setting member, preferably a diaphragm, with another member that provides different keystroke resistance characteristics. Thus, the method can involve opening the keyboard, removing a first member, installing a second member that provides different keystroke resistance, and closing the keyboard. Other components can also be changed and/or added.

The invention also provides an additional method for modifying the appearance of a keyboard by providing a thin overlay that is placed over the upper housing piece. The overlay can be a film, but preferably is a thin layer, e.g., 0.3-2 mm thickness. The overlay has openings to accommodate the keys in the keyboard. Preferably the overlay adheres to the keyboard housing, e.g., with a releasable adhesive, by friction fit, or by electrostatic interaction. The overlay can, for example, alter the keyboard appearance by changing the color, texture, pattern, and/or text or characters on the keyboard. The invention also concerns such overlays, sets of overlays, and kits containing such overlays, alone or in combination with one or more key or key cap sets and/or resistance setting members.

As used herein in connection with keyboard overlays, the term “thin” means 3 mm or less, preferably 2 mm or less, and still more preferably 1.5, 1.0, 0.7, or 0.5 mm or less.

Additional features and embodiments of the present invention will be appreciated from review of the following detailed description of the invention, along with the accompanying and of the claims.

### BRIEF DESCRIPTIONS OF THE DRAWINGS

FIG. 1 is a simplified plan view illustrating an operator's left forearm, wrist and hand actuating a conventional electronic computer keyboard (the hand is shown in two different positions in solid lines and phantom lines).

FIG. 2 is an enlarged diagrammatic vertical sectional view of a portion of an electronic computer keyboard that may be utilized to carry out the method of the present invention.

FIG. 3 is a simplified plan view similar to FIG. 1 illustrating an operator's left forearm, wrist and hand actuating an electronic computer keyboard that may be utilized to carry out the method of the present invention (the hand, wrist and forearm are shown in a first position in solid lines and in a second position in phantom lines).

FIG. 4 is an enlarged partially exploded and partially vertical sectional view through a portion of an electronic computer keyboard illustrating the manner in which its individual key support assemblies can be retrofitted with elastomeric booster springs to increase keystroke resistance.

FIG. 5 is a top plan view of the key support assembly illustrated in FIG. 4.

FIG. 6 is a bottom plan view of the key illustrated in FIG. 4.

FIG. 7 is a perspective view of the elastomeric booster spring illustrated in FIG. 4 showing its rib receiving slits.

FIG. 8 is side elevation view of the booster spring of FIG. 7.

FIG. 9 is a vertical sectional view through the key and elastomeric booster spring of FIG. 4 showing, the manner in which they mate (the associated key support assembly is shown in phantom lines).

FIG. 10 is a plan view of an elastomeric template that may be used to simultaneously retrofit multiple keys of a conventional electronic computer keyboard.

FIG. 11 is an enlarged vertical sectional view of the elastomeric template taken along line 11-11 of FIG. 10.

FIG. 12 is a fragmentary perspective view of a plurality of cylindrical booster springs made of an elastomeric material interconnected by an elastomeric tree structure.

FIG. 13 is a side elevation view of an alternative embodiment of the present invention illustrating a hinged keyboard.

FIG. 14 is a side elevation view of another embodiment of the present invention.

FIG. 15 is a plan view of the embodiment of FIG. 13, illustrating the elastomeric template positioned within the keyboard.

FIG. 16 is an enlarged cross-sectional view of the elastomeric template taken along line 16-16 of FIG. 15.

FIG. 17 illustrates a flowchart of an embodiment of a modular keyboard system constructed according to the present invention.

FIG. 18 illustrates a flowchart of an alternative embodiment of a modular keyboard system constructed according to the present invention.

FIG. 19 illustrates a flow chart of yet another embodiment of a modular keyboard system constructed according to the present invention.

FIG. 20 is a side elevation view of another embodiment of the present invention that includes a storage area.

FIG. 21 is a bottom view of the embodiment illustrated in FIG. 20.

### DETAILED DESCRIPTION OF PREFERRED EMBODIMENT

The present invention provides modular keyboards for computers as well as other electronic devices, that are constructed to allow the keyboard to be conveniently opened and components replaced. Whereas conventional computer keyboard are typically constructed with an upper housing piece and a lower housing piece held together with four or more, often 8-16, screws, opening the present keyboards involves the removal of no more than two, preferably no more than one, and more preferably no screws. In addition to being easily opened, the present keyboards can also be constructed so that particular components are readily replaced.

Thus, the invention can utilize one design with respect to fit of components, but provide many variations by using changeable components that are configured to fit that design. For example, the changeable components can include different, interchangeable housing pieces that each fit with the same keys, switches, storage areas, and/or liquid resistance barriers. As a result, the keyboards are referred to as modular keyboards, due to the interchangeability of components.

Openable Keyboards

As briefly described above, the present keyboards are openable, and the top housing piece and/or other components, in most cases, can be accessed and replaced without tedious removal and replacement of numerous screws. A variety of different structures and variations can be used to make keyboards readily openable. Certain non-limiting selections and examples are discussed and/or shown in drawings herein.

In most cases, the keyboards are constructed with a housing that splits the keyboard into upper and lower portions, with the upper and lower portions preferably held together using releasable snaps, clips, clamps, cam-locks, twist-locks, hinges, detachable hinges, tabs, latches, keys, holders, mating members, hooks, pins, or other releasable, non-screw-type fasteners. As noted screws can be used, e.g. a small number of screws such as 1 or 2, but are not preferred. In embodiments where a screw(s) is used, highly preferably the screw and receptacle are durable. For example, a screw can thread into a material that allows a large number of removals and replacements without stripping or wearing out the threads. Thus, preferably a screw threads into metal (e.g., a metal insert in the plastic housing) or into a highly durable plastic (e.g., a hard and high strength plastic). Another exemplary embodiment is plastic screws, threaded into plastic or metal. The screw head can be configured for a screwdriver or other driver tool, or can be configured for removal and replacement without requiring tools, e.g., with a head shape that allows a person to grasp the head firmly and apply sufficient torque to remove and replace the screw. Exemplary materials for plastic screws include high density polyethylene, with screw diameters preferably at least 4 mm, e.g., in a range of 3-10 mm. Preferably the screw head includes a gripping surface 5-30 mm across in the widest lateral dimension, more preferably 7-25 mm or 8-20 mm.

In certain embodiments, the housing pieces are held together due the respective shapes of the housing pieces. For example, the upper housing piece can slip over the outside of the lower housing piece, e.g., a slip fit or a spring fit, such that the pieces are held together by sliding friction and/or spring pressure of a housing piece against another. Such friction or spring fits can involve all or only portions of the housing pieces, e.g., portions of the perimeters of the housing pieces. Similarly, housing pieces can be constructed to have a snap fit, e.g., at least a portion of the periphery of the upper or lower housing piece snaps into a slot in a corresponding housing piece or a ridge on an upper or lower housing piece snaps past (i.e., rides over) a matching ridge or into a complementary groove in a complementary housing piece. For keyboards held together in this manner, preferably the keyboard housing pieces also have constructs that allow a normal person to grasp the mated pieces allowing the housing pieces to be pulled apart, and/or have lever fittings allowing insertion or a actuation of a lever that forces the housing pieces apart, e.g., a slot or slots for insertion of a coin, screwdriver, or other such objects. Such friction, spring fit, or snap retention can be supplemented, if desired, with one or more fasteners.

As was discussed above, provision of openable keyboards allows convenient substitution or replacement of a number of keyboard components, including the upper and lower housing pieces. Substitution of the upper portion of the housing is particularly advantageous (alone or in combination with replacement of key caps or key assemblies) as it allows the appearance and/or key configuration to be readily changed. Changes of key configurations allows keys to be located differently, and/or for a different number of keys to be present. For example, a switch set in a keyboard need not have keys corresponding to all key positions in a key configuration, while one or more of the previously unused switches can have a corresponding key in an alternate key configuration. This allows, for example, the inclusion of special purpose or additional character keys (e.g., keys corresponding with characters present in a language such as German, but not in English).

Replacement keyboard components, especially externally visible components, can be provided with a variety of different characteristics. For example, components such as upper housing pieces, lower housing pieces, and key caps can be provided in various colors and/or textures. Pigments to provide the various colors can be used in conventional ways, e.g., incorporated in plastics. Examples of such colors include blue, red, pink, purple, lavender, silver, yellow, and gold, as well as the more conventional colors of beige, tan, black, and gray. In certain embodiments, the keyboard component(s) is not beige, tan, black, or gray.

In addition to the usual hard, smooth or slightly roughened surface textures, outer surfaces of keyboards can be rough, textured with a recognizable pattern, patterned with a recognizable visual pattern or image (such as a picture), soft, or rubbery (for example, the surface is formed of an elastomeric material).

Keyboard components can also be provided that provide a hand rest area, e.g., a keyless area where the heel of a user's hand is normally positioned. Such rest areas are sometimes provided in conventional keyboards, e.g., “ergonomic” keyboards or provided as a separate handrest that is placed in front of the keyboard. The present keyboards can have such a handrest incorporated in the upper housing piece or lower housing piece, or removably attached to the front of the keyboard, e.g., using fasteners of a type listed in connection with keyboard housing fasteners.

Keyboard, as well as kits for modifying keyboards, can also be supplied with instructions for carrying out modification of a keyboard, e.g., installing or interchanging one or more keyboard components. Such instructions can be printed (text and/or pictures), and/or audio and/or video presentations. In certain embodiments, the instructions are packaged together with or part of one or more keyboards or kits. Thus, the instructions can be part of, attached to, packaged with, or separate from but associated with a keyboard(s) or keyboard component(s).

Key Replacement

Either alone or in conjunction with replacement of the upper housing piece, some or all of the keys or keycaps can be replaced. This allows, for example, the appearance of the keys to be matched to the upper housing and/or for the key configuration to be changed, e.g., for the labeling of the keys to be changed to match a particular key layout and/or for a different key set to be used (e.g., more or fewer keys than in another key set usable in the particular keyboard). Appearance and labeling changes can be made by changing keycaps, i.e., the upper, visible portion of a key or by changing keycaps along with associated structure related to retention of the key and/or actuation of switches. The keys or keycaps can be changed individually, but preferably are changed as a set. This can most readily be accomplished if the keys lift off with the top housing piece, or as a set with an intermediate or internal piece, for example, a sheet or plate through which the keys penetrate and in which they are retained. Alternatively, the keys can be replaced as a set along with a switch set, e.g., a template that contains corresponding switches and can also include the corresponding keystroke resistance setting members.

The key set and/or switch template can be retained in the housing with screws, but preferably is retained by closure of the keyboard and/or with releasable clips, snaps, or other releasable fasteners.

Keys can be marked with characters or symbols selected for a particular use, e.g., symbols used in representing a human language such as English, Spanish, Russian, Japanese, or Chinese, or can be symbols for other applications, such as numerals or mathematical symbols, symbols related to directing play for computer games, fanciful characters, and computer function symbols.

Keystroke Resistance Setting Constructs

An additional component or set of components that can be usefully replaced in the present keyboards are components that set the keystroke resistance. This allows changeable keystroke resistance, e.g., the keystroke resistance can be adjusted from light keystroke resistance to a significantly higher keystroke resistance, e.g., up to 300 grams. For example, the keyboard resistance can be set as the minimum keystroke resistance sufficient to prevent accidental switch closures otherwise resulting from the weight of the operator's fingers resting on the keys. This encourages the operator to move his or her hands over the keyboard with locked wrists. It also eliminates the need for the operator to hold his or her hands up to prevent inadvertent key depressions, thereby reducing stress and fatigue on the operator's shoulders, forearms, wrists and hands.

Conventional electronic computer keyboards have keys that can be depressed with less than seventy grams of force and with less than five millimeters of keystroke length. The problem with this type of “light touch” design is that an operator tends to angle his or her wrists back and forth as much as thirty degrees in reaching for various keys. Furthermore, the weight of an operator's fingers combined with the natural downward flexing of the fingers is usually sufficient to depress a key. Therefore, the operator induces stress and fatigue in his or her wrists supporting the hands so that the fingers do not inadvertently depress the keys. If greater keystroke resistance and/or keystroke length were required in order to enter a particular letter, numeral, symbol or command, the operator would naturally tend to lock his or her wrists and move the hands over the keys, eliminating the severe wrist flexure. While this type of movement requires angling of the forearms by pivoting the shoulder, such angling is minimal, for example two to five degrees, and does not lead to injuries in the arms or shoulders. This may be due to the fact that the ball and socket construction of the shoulder joint is more conducive or natural to this type of side-to-side movement than the wrist joint.

Suitable exemplary methods and constructs for keystroke resistance setting members are described in U.S. Pat. No. 5,676,476, U.S. patent application Ser. No. 09/205,031, and PCT application PCT/US96/18835, and references cited therein, all of which are incorporated herein by reference in their entireties.

In particular embodiments, keystroke resistance setting members are constructed as an integrated set (e.g., in a diaphragm or template), preferably including resistance setting members for all the keys in a keyboard, or at least all the keys in a set of contiguous keys, e.g., the set of keys in a numeric keypad in a computer keyboard. The keystroke resistance may differ between keys. For example, the keystroke resistance may be individualized, e.g., depending on key function and/or position, or keys in different areas of the keyboard may have different keystroke resistance. Thus, in an exemplary arrangement, keys that are normally actuated by a user's little finger may have less keystroke resistance, and/or keys such as the spacebar or return key may have higher keystroke resistance. Both the levels of keystroke resistance and the pattern of keystroke resistance over a key set can be separately selected.

Keystroke resistance setting members, especially in a diaphragm arrangement, can be made of various materials, preferably elastomeric materials such as rubber, silicon, plastic, polyurethane, polypropylene, polyethylene, and combinations of those materials. Typically, an elastomeric material used for this purpose will have a hardness from 10 to 60 durometer on a Durometer A scale, preferably 20-50. In particular embodiments, the material is in a range 20-30, 30-40, or 40-50 durometer. An appropriate thickness for material, e.g., elastomeric material, in keystroke resistance setting members is typically in the range of 0.010 to 0.60 inch, preferably 0.020 to 0.05 inch. In particular embodiments, the material is 0.020-0.030 inch, 0.030-0.040 inch, or 0.04-0.05 inch thick. Keystroke resistance setting members can also be provide in various colors or colorless, e.g., to match, coordinate, or contrast with a housing or key color, or to provide different colors for members that provide different levels of keystroke resistance.

As indicated, the level of keystroke resistance can be selected. In most cases, the keystroke resistance will be in the range of 30-300 grams, more often 50-250 grams, and most often 50-220 grams. While most conventional computer keyboard have keystroke resistances near the lower end of those ranges, e.g., 30-70 grams, as described above and in the patent reference cited above, it can be advantageous to utilize higher resistance, e.g., 70-220 grams, 70-180 grams, 100-220 grams, or 100-180 grams.

Keystroke resistance setting members, such as diaphragms, can be provided together with a keyboard, as part of a kit, or separately, and such members can be provided singly or a plurality of preferably interchangeable members can be provided, e.g., at least 2, 3, 5, 8, 10, or more members. A plurality of such keystroke resistance setting members can be identical and/or a plurality of members can have different keystroke resistance setting characteristics.

Liquid Resistant Barriers

Still another component that can be replaced is a liquid resistant barrier. For example, a barrier can be inserted in a keyboard that is not liquid resistant to make that keyboard resistant. Generally, such a barrier directs liquids that are spilled on the key area of the keyboard away from electronic keyboard components, and are often designed in conjunction with keyboard housings such that liquid is directed into a channel(s) that carry the liquid to the exterior of they keyboard or into a well(s). Such barriers, corresponding adaptations to keyboard housing pieces, and the use of such components are described in Uke, U.S. patent application Ser. No. 10/156,737, filed May 29, 2002, and Uke, U.S. patent application filed Oct. 9, 2002, serial number not yet assigned, entitled KEYBOARD ASSEMBLIES, which are incorporated herein by reference in their entireties including drawings, and can be used in the present keyboards.

Storage Areas

The present keyboards can also be configured to provide replacement or addition of storage areas. Exemplary storage area constructs that can be adapted to be replaceable are described in Uke, U.S. patent application Ser. No. 10/156,736, filed May 29, 2002, and Uke, U.S. patent application filed Sep. 12, 2002, serial number not yet assigned, entitled COMPUTER KEYBOARD WITH STORAGE AREA, which are incorporated herein by reference in their entireties, including drawings. As described therein, storage areas can be adapted for storing a variety of different data storage media and/or other items, including, for example, compact disks, floppy disks, memory cards, flash memory cards, digital versatile disks, paperwork, operating manuals, keystroke resistance setting members, and the like.

In the present keyboards, one or more storage areas can be incorporate in a keyboard housing, or can be removable. Thus, a keyboard can be provided with or without a storage area, and one or more storage areas can be attached, or storage areas can be removed or changed for different storage areas. In many cases, the storage area(s) will be located in or attached to the bottom of the keyboard. Attachment can be performed using many different fasteners, preferably removable or releasable fasteners, such as those indicated for use in holding upper and lower keyboard housings or members together.

Such storage areas can be constructed in many different ways, e.g., as described in the patent references above, but will usually be constructed at least in part of a moldable or castible plastic.

Keyboard Overlay Cover

In addition to the use of interchangeable upper housings, overlays can be used to alter a keyboard, which can be a conventional keyboard or an openable keyboard. Such overlays are thin and conform to the upper surface of a keyboard, but do not cover the keys. Typically the overlay will be no more than 2 mm thick, usually no more than 1 mm thick, often no more than 0.8, 0.6, 0.5, 0.4, 0.3 mm, or even less. In most cases, the overlay is formed of a moldable plastic.

Such overlays can alter surface characteristics in similar manner to changes of upper keyboard housings, e.g., color, texture, image, pattern, characters (such as non-English characters). The overlay is placed over the upper keyboard housing. Rigid or semi-rigid overlays can be retained in position by gravity, or can be clipped or otherwise fastened with a fastener or by friction between the overlay the sides of the keyboard, or can be adhered to the keyboard, e.g., with a releasable adhesive.

In addition, thin, flexible, or film-type overlays can be used. Such overlays are preferably retained in position by interaction between the overlay surface and the keyboard housing. For example, an overlay can be adhered using an adhesive, preferably a releasable adhesive, or by an attractive interaction between the surfaces, e.g., electrostatic interaction. In many cases, such flexible overlays will be no more than 0.5 mm thick, or even 0.3 mm or less, 0.2 mm or less, or 0.1 mm or less.

A number of non-limiting embodiments and optional structures for the present keyboards are illustrated in the figures. As described above, an important aspect of the invention the use of openable keyboards and interchangeable housings, e.g., as exemplified in FIGS. 13-15. First, however, the general structure of a computer keyboard is described, along with embodiments concerning the replacement of keystroke resistance setting members

Referring to FIG. 1, a conventional electronic computer keyboard KB is illustrated which includes a first plurality of keys, including keys K1 and K2, arranged in the standard QWERTY key format, and a second plurality of keys K3 arranged to the side normally including numeral keys and command keys. The conventional electronic computer keyboard KB also includes a space bar (not illustrated) adjacent the lower edge, function keys (not illustrated) adjacent the upper edge and other command keys (not illustrated). The conventional electronic computer keyboard KB is constructed in well-known fashion and includes an outer frame, a plurality of keys each having guide posts received in corresponding guide mechanisms mounted in the frame. Springs normally surround the guide posts and bias the keys upwardly. The lower ends of the guide posts are located above corresponding switches which may have a laminated membrane-type construction, for example. Typically the springs are selected so that the keystroke resistance force is approximately seventy grams. This is the average approximate force required to be applied by the operator's fingers to depress a key sufficiently to cause the lower end of its associated guide post to actuate the corresponding switch and close electrical contacts therein.

Electrical signals are generated and recognized by the mother board of the personal computer as indicating that the operator has depressed a particular key at a particular moment. Normally the guide post associated with each key and the guide mechanism associated with each guide post are configured so that the key travels less than five millimeters between its uppermost and lowermost positions. The keystroke is thus the distance a key travels from its raised at rest position to its fully depressed position in which the lower end of its guide post actuates the associated electrical switch.

Referring still to FIG. 1, the conventional electronic computer keyboard KB has such a light touch, i.e., requires so little force and/or so little keystroke travel to actuate the associated switch, that the only necessary movement of the operator's hand is to shift to operate other keyboards. Thus, it is only necessary for the operator's hand to shift as shown in FIG. 1, where, for example, the operator's hand H shifts angularly between the position P1 shown in solid lines and the position P2 shown in phantom lines. This causes the operator's wrist W to move through a substantial angle θ which can be as much as thirty degrees. When the operator's hand H moves between the positions P1 and P2, his or her forearm F remains more or less stationary. The type of hand and wrist movement illustrated in FIG. 1 can occur, for example, when the user first depresses one key of the set K1 with his or her ring finger and then moves to depress one key of the set K2 with the same finger. It is the back and forth repetitive movement of the operator's wrist W through the angle θ that may lead to physical injury. If the operator rests his or her hands on the keys of the keyboard KB, the weight of his/her fingers will depress the keys and close the associated switches.

Referring to FIG. 2, an electronic computer keyboard 10 includes a plurality of keys 14. Each key 14 is connected to or formed with, such as by injection molding, a downwardly extending guide post 16. Only the center key 14 is shown with its guide post 16 in FIG. 2. The electronic computer keyboard 10 further includes one or more vertically spaced guide plates 18 having holes for slidably receiving the guide post 16 of each of the keys 14. Only one hole is shown in the guide plate 18 for the sake of clarity. For simplicity, only the structure associated with the center key 14 will be described. It will be understood that all the other keys 14 have similar guide posts, guide mechanisms and associated switches.

The guide post 16 and guide plate 18 form a guide mechanism for permitting vertical reciprocal movement of the key 14. Beneath the lower end of the guide post 16 is a laminated membrane-type switch assembly 20 including a plurality of electrical switches. Each of these switches is located directly beneath the curved lower end of a corresponding guide post 16. A coil spring 22 surrounds the guide post 16 of the key 14. The spring 22 is compressed between the key 14 and the guide plate 18. A retainer 24 surrounds the lower end of the guide post 16 to prevent the key 14 from falling out of the keyboard 10. The foregoing components are all mounted in, and supported by, a surrounding plastic frame illustrated diagrammatically by phantom line 26. The key 14 is normally biased upwardly to its at rest position by the spring 22. The key 14 can be pushed downwardly by an operator's finger through a predetermined keystroke length SL to cause the lower rounded end of the guide post 16 to engage and close the associated electrical switch in the laminated switch assembly 20.

In accordance with the present invention, the compressive strength of the spring 22 is selected to provide the minimum keystroke resistance sufficient to prevent accidental switch closures from the weight of the operator's fingers resting on the alphanumeric keys. This keystroke resistance will typically be a minimum of about seventy grams. The keystroke resistance is the amount of force that must be applied by an operator's finger in a downward direction to cause the lower end of the guide post 16 to close the associated switch in the switch assembly 20. Also, in accordance with the present invention, the keystroke length SL may also be selected to achieve therapeutic results in combination with the increase in keystroke resistance. A keystroke length SL of greater than about five millimeters, and more preferably, greater than about ten millimeters may be beneficial. The keystroke length SL is defined as the distance that the key 14 must travel from its uppermost, at rest position, to its lowermost position in which the lower end of the guide post 16 engages and closes the corresponding switch in the switch assembly 20.

The effective upper limit for both the keystroke resistance and keystroke length would in all likelihood be those exhibited by conventional, non-electric typewriters, such as those sold for many years in the United States prior to 1960 under the Trademarks UNDERWOOD, SMITH CORONA, ROYAL and others. Most electronic computer keyboard operators would probably dislike a keystroke resistance higher than three hundred grams. A preferred range would be between seventy grams and two-hundred twenty grams, and more preferably, between about ninety grams and one hundred and twenty grams. Of course large keys, such as the space bar, preferably have a higher keystroke resistance than that of the alphanumeric keys since the weight of more than one finger will normally rest on the same.

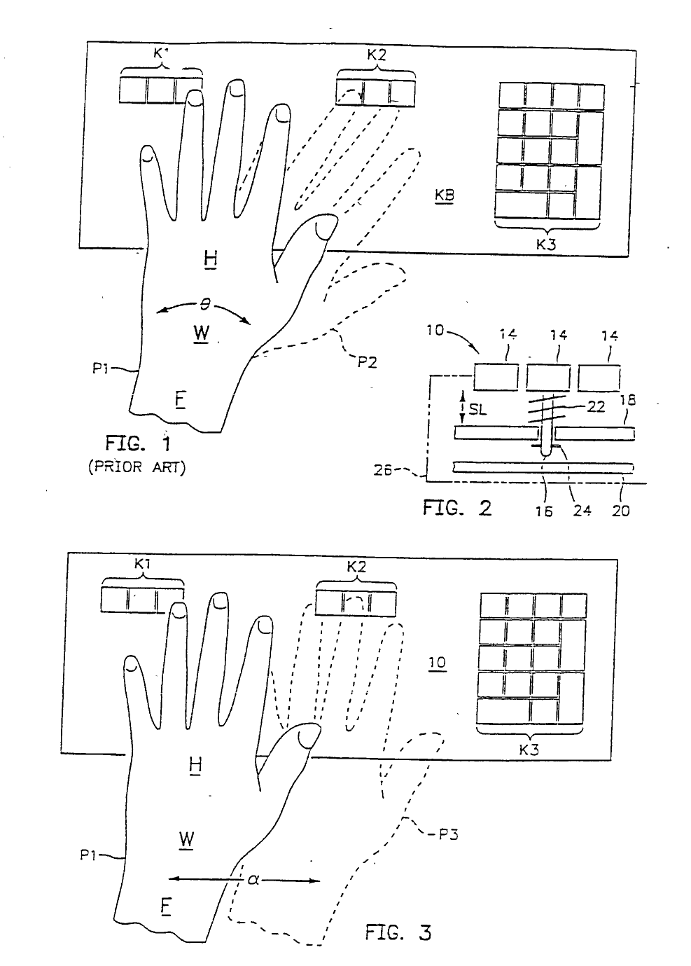

FIG. 3 illustrates the movement of the operator's hand H, wrist W and forearm F when he or she uses the electronic computer keyboard apparatus 10 constructed in order to carry out the method of my invention. More particularly, when the operator wishes to depress the far right key of the set K1 with his or her ring finger, and then depress one of the keys of the set K2 with his or her middle finger, it is necessary for the operator to lock his or her wrist W. In FIG. 3, the initial position of the operator's hand H, wrist W and forearm F is shown in solid lines. When moving between the keys K1 and the keys K2, the operator's hand, wrist and forearm move from the position P1 shown in solid lines to the position P3 shown in phantom lines. In this operation, the operator's wrist is locked and no longer swings through the angle 8. Instead, the operators forearm F moves through a much smaller angle, α, typically less than ten degrees. Because the operator has locked his or her wrist, the tendency to develop an injury to the shoulders, forearms, wrists or hands from repetitive movements associated with the operation of the electronic computer keyboard 10 is greatly reduced when the keyboard is operated for an extended period to enter text and/or numbers into an application on a computer associated with the keyboard compared to a conventional electronic keyboard KB (FIG. 1). The extended period could be several hours in a given day over weeks or months.

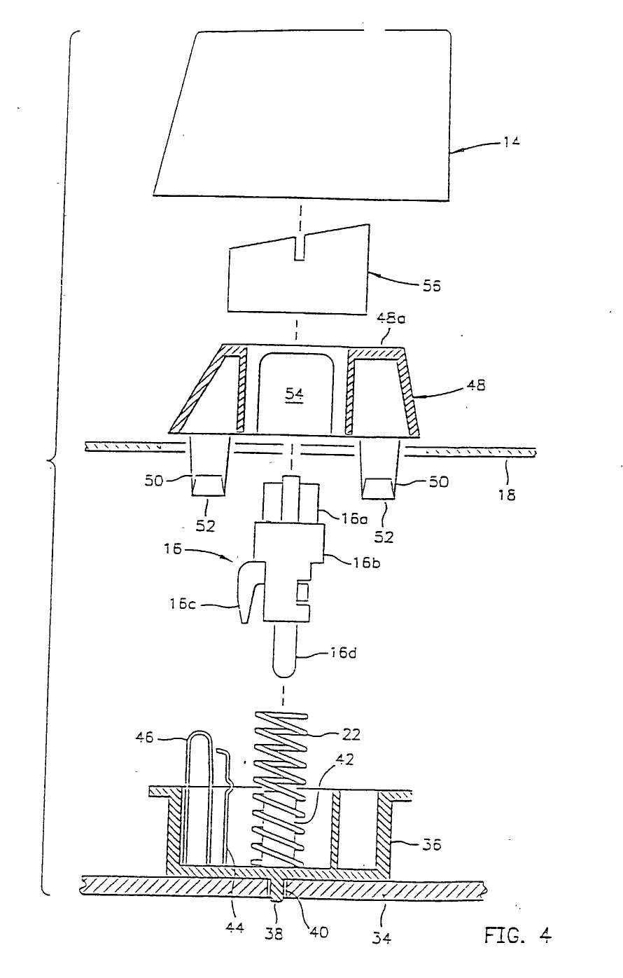

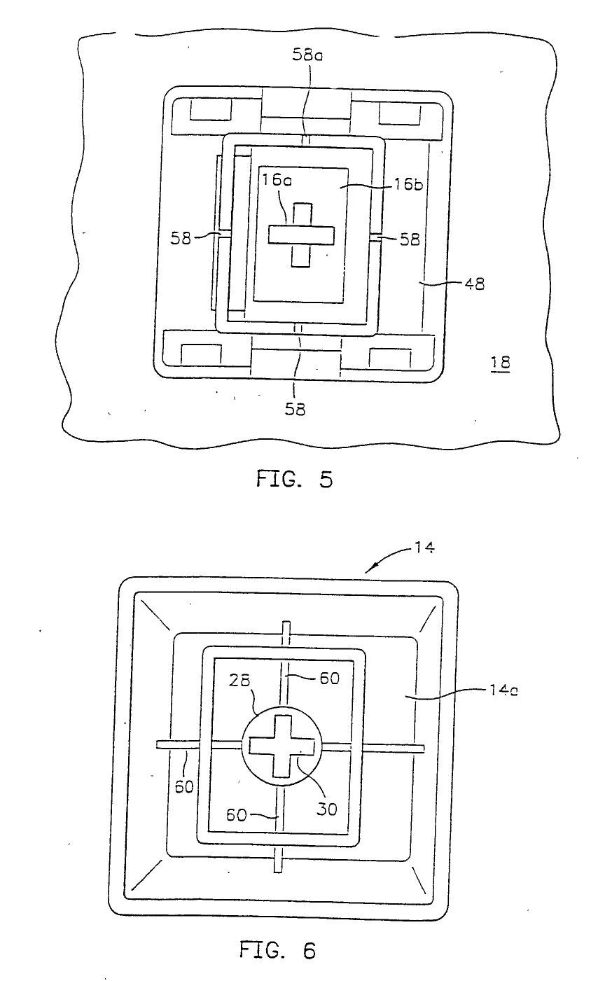

FIGS. 4-9 illustrate another electronic computer keyboard construction which is particularly suited to retrofitting existing electronic computer keyboards to provide increased keystroke resistance. All of its keys, switches and guide mechanisms are similar so only one will be described. Each key 14 is made of injection molded plastic and includes a downwardly extending cylinder 28 (FIG. 6) having a centrally located crisscross shaped hole 30. The upper end 16a (FIG. 4) of the guidepost 16 has a crisscross shape so that it can be snugly received into the hole 30 in the cylinder 28. A PC board 34 (FIG. 4) supports an upwardly opening box-shaped receptacle 36. The receptacle 36 has a downwardly extending projection 38 which is received in a locating aperture 40 in the PC board 34. Inside the receptacle 36 is a centrally located vertical guide tube 42. The lower half of the coil spring 22 surrounds the guide tube 42.

The guide post 16 (FIG. 4) has a main body 16b from which projects a hook shaped actuator 16c. The guide post 16 has a cylindrical, rounded lower segment 16d that slides upwardly and downwardly within the guide tube 42. During this motion, the actuator 16c moves an inverted L-shaped copper switch element 44 into and out of contact with U-shaped copper switch element 46. This makes and breaks a circuit connection. The switch elements 44 and 46 are connected through the receptacle 36 to circuit traces (not illustrated) on the upper surface of the PC board 34.

A key support assembly 48 (FIGS. 4, 5 and 9) is mounted over the top of the receptacle 36 and held in place by four downwardly extending tabs 50. The tabs 50 have projections 52 which seat in corresponding detents (not illustrated) formed in opposite vertical sidewalls of the receptacle 36. The key support assembly 48 has an aperture 54 which extends vertically there through. The guide post 16 reciprocates upwardly and downwardly through the aperture 54 of the key support assembly 48. A rectangular elastomeric booster spring 56 is seated between the upper generally horizontal surface 48a of the key support assembly 48 and the underside 14a (FIG. 6) of the key 14. In this embodiment the coil spring 22 serves as a base spring and the elastomeric spring 56 serves as a booster spring. Together they provide the keystroke resistance. The elastomeric booster spring 56 is made of a material having a suitable durometer or hardness necessary to achieve the keystroke resistance in the ranges identified above. By way of example, suitable elastomeric materials include polyurethane, polypropylene, polyethylene, and various blends of these materials. Synthetic and natural rubbers could also be utilized. The foregoing list of materials is meant to be exemplary, and not exclusive. The booster spring 56 has an overall rectangular configuration including four sidewalls 56a, 56b, 56c, and 56d. The sidewalls 56a and 56d have inclined upper edges to ensure proper engagement with the underside 14a of the key 14 which is typically angled relative to the upper surface 48a of the key support assembly 48. Each of the sidewalls has an upwardly opening vertical slit 58. The slits received corresponding downwardly extending ribs 60 (FIG. 6) formed on the underside 14a of the key 14. In this manner, the booster spring 56 is centrally located in position between the spring 14 and the underlying key support assembly 48.

The electronic computer keyboard construction illustrated in FIGS. 4-9 is particularly adapted to retrofitting existing electronic computer keyboards. Sets of elastomeric booster springs can be sold in packages at retail computer outlets. Individual computer owners can remove the keys from their electronic computer keyboards relatively easily, insert the booster springs in position, and replace the keys. Alternatively, this could be done as service by a retail computer outlet. The booster springs would be available in range of durometers so that a user could select a particular keystroke resistance fitting his or her particularized needs. Alternatively, the booster springs could be installed by original equipment manufacturers (OEMs) of electronic computer keyboards.

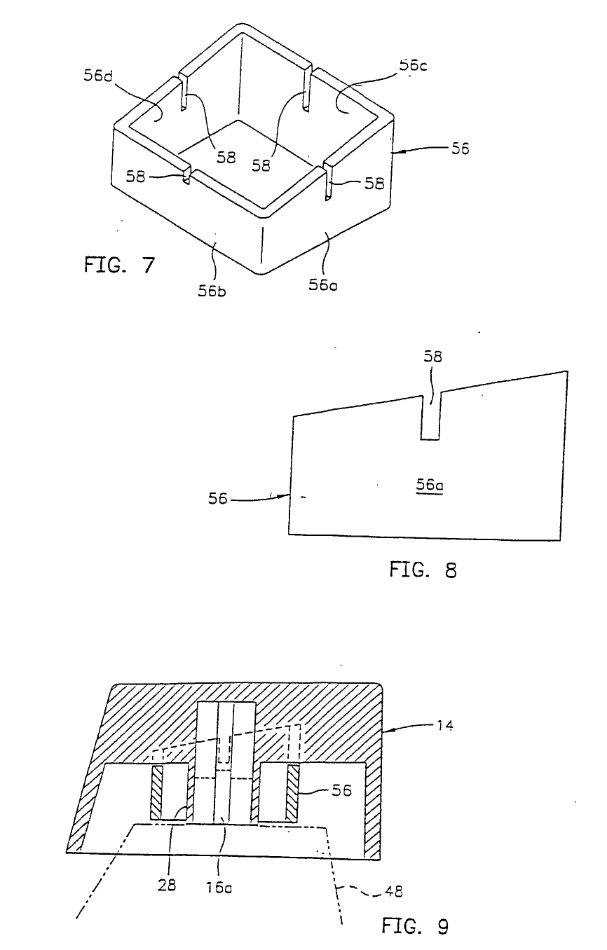

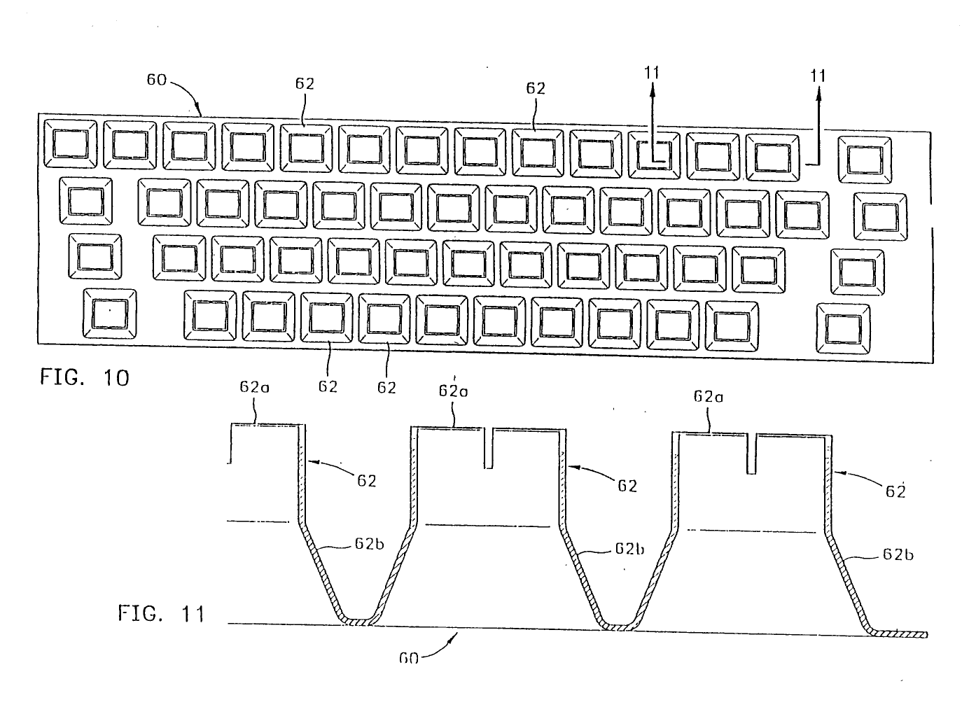

FIGS. 10 and 11 illustrate a preferred alternate way to modify existing electronic computer keyboards in order to perform the method of the present invention. An elastomeric template 60 is injection molded, or otherwise formed as a single unitary piece of elastomeric material having a waffle-like configuration. More particularly, as best seen in FIG. 11, a plurality of individual booster spring elements 62 are connected to one another in spaced apart, uniform fashion. The upper portion 62a (FIG. 11) of each booster spring element 62 has the same configuration as the booster spring 56 (FIGS. 7 and 8). The lower portion 62b of each booster spring element 62 is flared in order to fit around and enclose the corresponding key support assembly 48 (FIG. 9). Thus, the template 60 may be utilized by OEMs during the fabrication of electronic computer keyboards to rapidly provide the required keystroke resistance for each of the keys, without the necessity of installing a large number of individual booster springs.

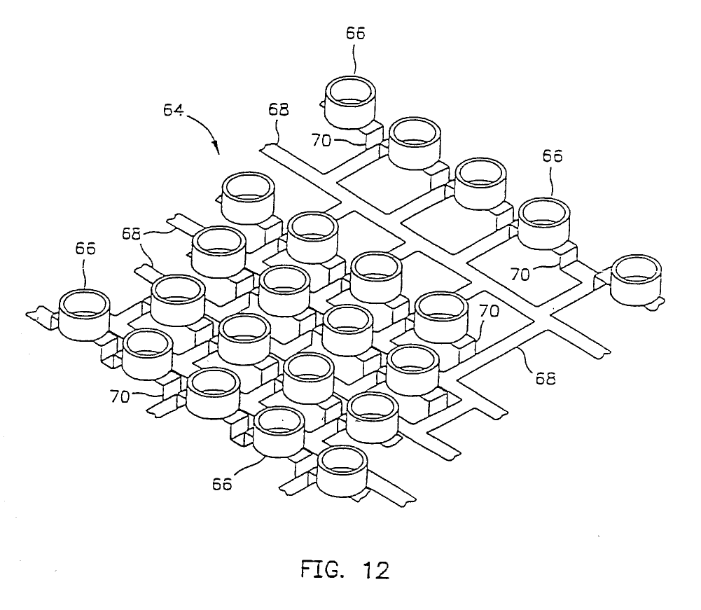

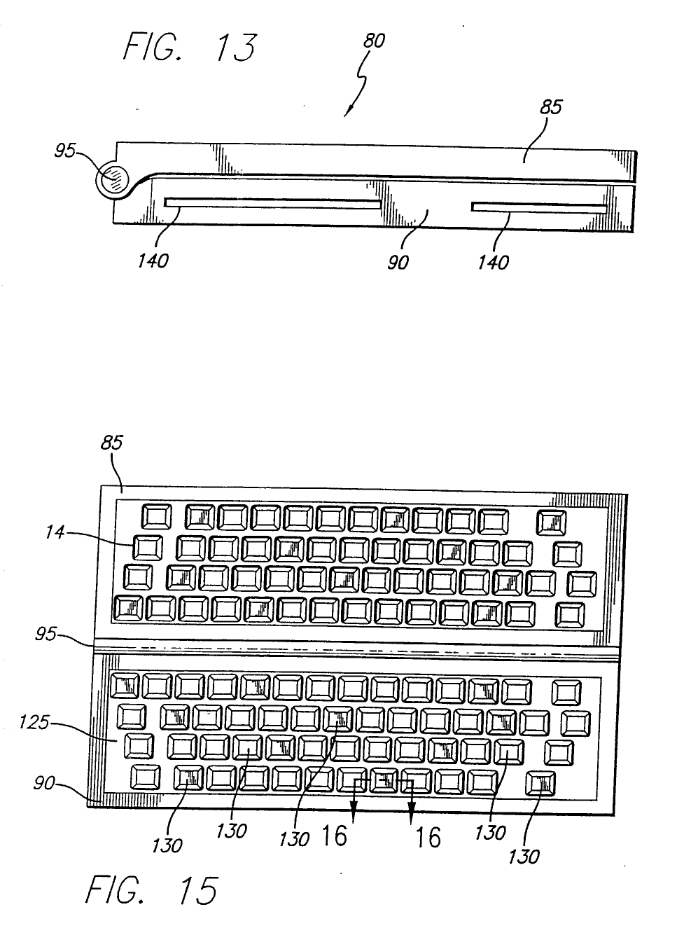

FIG. 12 is a fragmentary perspective view of a still further way to modify existing electronic computer keyboards. A lattice structure 64 includes a plurality of cylindrical booster springs 66 made of an elastomeric material interconnected by a tree structure in the form of a plurality of elastomeric ribs 68. The lattice structure can be molded as one integral unit. The spacing of the cylindrical booster springs 66 is determined by the lengths of the row-oriented and column-oriented ribs 68. The ribs 68 are connected to the cylindrical booster springs 66 via L-shaped elastomeric connectors 70. This permits the booster springs 66 to sit on top of corresponding key support assembles 48. The connectors 70 extend downwardly around the sides of the key support assemblies 48. The ribs 68 therefore extend generally horizontally at a lower level between the keys 14 adjacent and parallel to the guide plate 18 (FIGS. 4 and 5). The lattice structure 64 is particularly suited for OEM manufacturing.

FIGS. 13-15 illustrate a hinged or otherwise openable embodiment in which the keystroke resistance also is selectable, and the upper keyboard member is preferably replaceable. Preferably, keystroke resistance is set by a resistance setting member or diaphragm 125, such as the elastomeric templates 60 described above with reference to FIGS. 10-12. A plurality of diaphragms 125 can be constructed, with each diaphragm 125 having the same, or different keystroke resistance profiles. In addition, a diaphragm 125 may be constructed so that individual keys may have individual resistance. For example, the “space bar,” “enter,” “shift” or any other key on the keyboard may have a higher or lower keystroke resistance relative to the other keyboard keys.

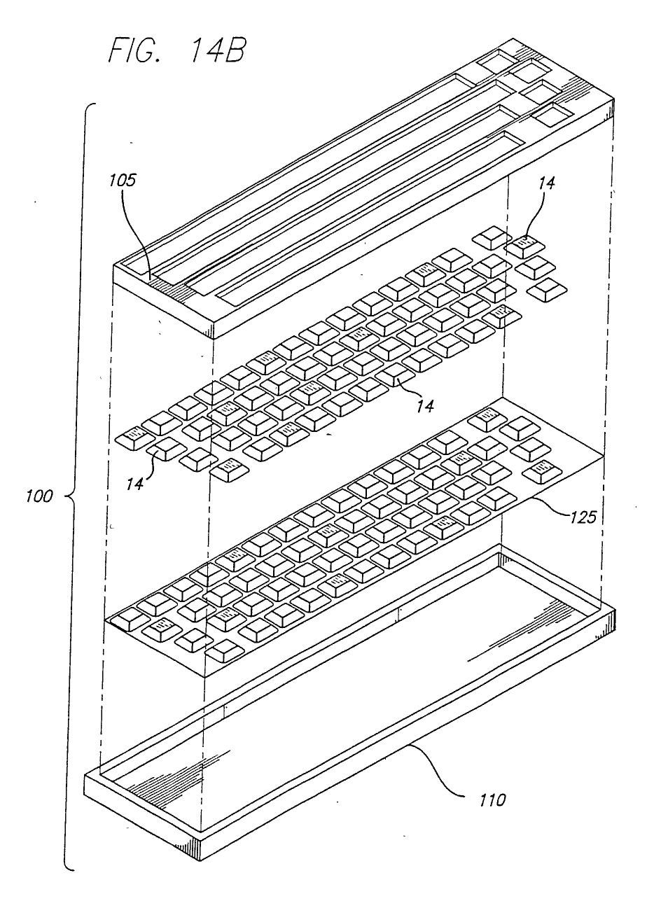

A user or retailer may alter the keystroke resistance of either keyboard 80 or 100 by opening the keyboard and providing a diaphragm 125 with a different keystroke characteristic. Although the user selects and changes diaphragms 125 in the preferred embodiment, other embodiments provide other structures to adjust keystroke resistance. For example, the user may select and set one or more springs that set the keystroke resistance for one or more keys, one of which is illustrated in FIG. 16. FIG. 16 shows a diaphragm element 130 with a diaphragm spring 135 positioned beneath the diaphragm element 130. Any suitable apparatus of setting keystroke resistance may be used. Alternatively, the diaphragm 125 may be semi-permanently installed in the keyboard 80 or 100. For example, a single diaphragm 125, that provides a desired keystroke resistance may be installed in the keyboard 80 or 100, and may only be replaced if it deteriorates in performance.

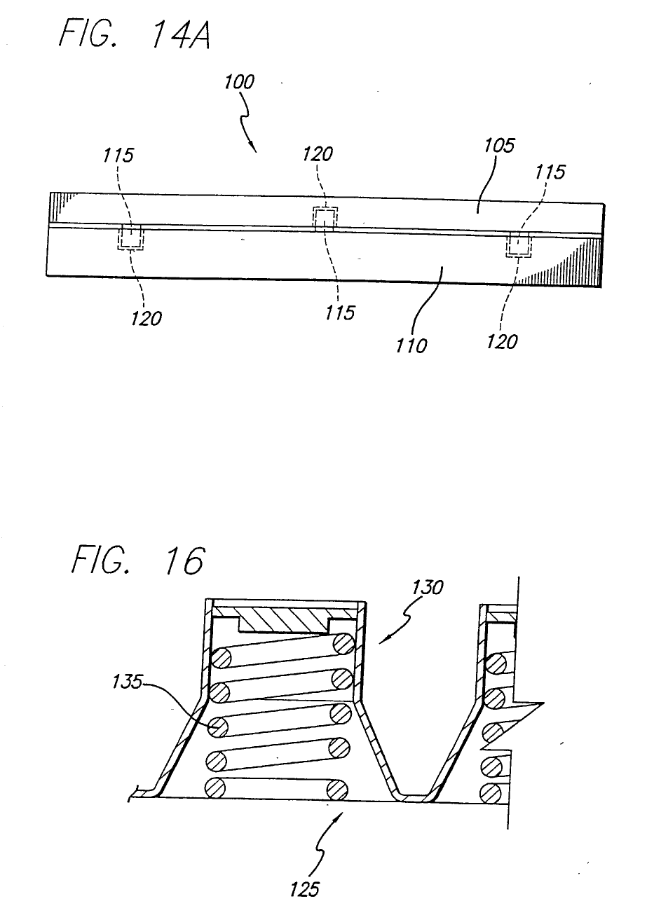

One embodiment provides a keyboard 80 or 100 constructed so that a user has access to the interior of the keyboard 80 or 100, and is able to modify the keystroke resistance for the keyboard 80 or 100. As illustrated in FIG. 13, a hinged keyboard 80 includes an upper keyboard member 85 and a lower keyboard member 90. A hinge 95 rotably couples the upper keyboard member 85 with the lower keyboard member 90. The hinge 95 can be replaced with other devices for removably or rotatably attaching the upper keyboard member 85 to the lower keyboard member 90. For example, FIGS. 14A and 14B illustrate a keyboard 100 having a cover member 105 and a base member 110 with projecting tabs 115 in the cover member 105 and tab receivers 120 in the base member 110. Other devices and arrangements can be used to removably attach the two keyboard members 105 and 110. For example, the keyboard members 105 and 110 may be releasably snapped together, use fasteners or may use other suitable joining devices. One possible joining device for the keyboard members 105 and 110 may include one or more “detachable hinges.” This type of hinge permits the two keyboard members 105 and 110 to be separated when the two keyboard members are rotated about 180 degrees relative to each other. For example, one or more detachable hinges would couple the two keyboard members 105 and 110 together when the keyboard 80 or 100 is closed, but when the cover member 105 is rotated about 180 degrees relative to the base member 110, the two keyboard members may separate from each other. Alternative embodiment detachable hinges would permit separation of the two keyboard members 105 and 110 at less than 180 degrees of relative movement.

FIG. 14B is an exploded view of the keyboard 100 illustrated in FIG. 14A. As described in detail below, the base member 110 is structured to receive a diaphragm 125. The cover member 105 is structured to receive a plurality of keyboard keys 14. Each of these components are designed to be interchangeable to suit the requirements of individual purchasers.

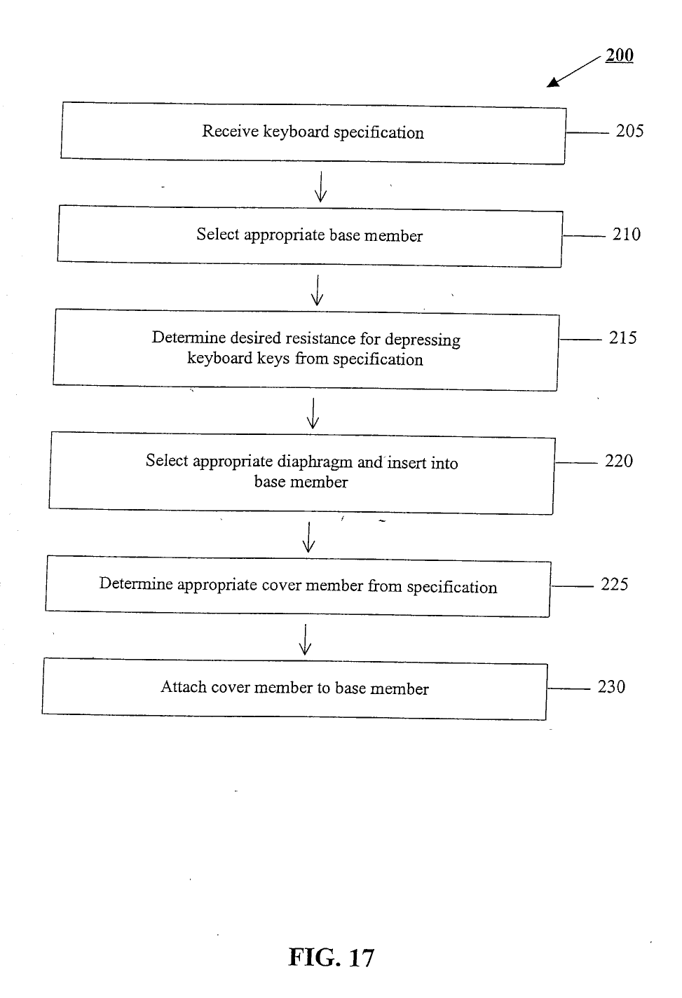

Referring to FIG. 17, one method 200 of practicing the present invention by assembling a modular keyboard system is illustrated. In step 205, a manufacturer, distributor, or other entity may receive a keyboard specification defining a specific arrangement or configuration of keyboard components. In step 210, based on the keyboard specification, an appropriate base member 110 is selected. The base member 110 may be a specific color, substantially transparent, or it may be constructed of a colored, substantially transparent material.

In step 215, the specified resistance for depressing the keyboard keys is determined from the specification. In step 220, the appropriate diaphragm 125 that provides the specified resistance is selected and inserted into the base member 110. If necessary, the diaphragm 125 may employ diaphragm springs 135 to generate sufficient resistance. The diaphragm 125 may also be colored or be substantially transparent. In step 225, the cover member 105 is selected by referring to the keyboard specification. The cover member 105 may be colored to match the base member 110, or it may coordinate or contrast with the base member 110.

In addition, the method 200 of modular keyboard assembly may include a request for colored keyboard keys 14, which may be inserted into the cover member 105 during the assembly process. The keyboard keys 14 may be colored to match, coordinate, or contrast with the keyboard members 85 and 90, and/or the diaphragm 125. In addition, keys 14 marked with different characters or keys 14 that perform specific functions may be colored differently from other keys 14. For example, a keyboard 80 or 100 constructed for use with a personal computer may have a number of differently colored keys 14, with each color specifying a specific computer function or operation. Once the keys 14 are assembled with the cover member 105, the cover member 105 is attached to the base member 110, in step 230.

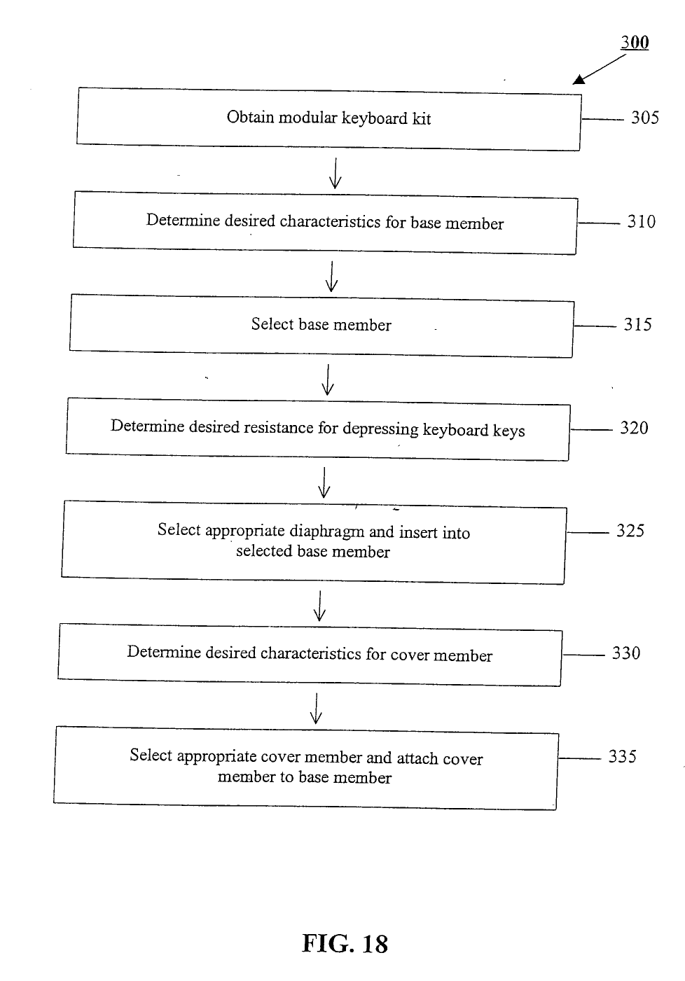

FIG. 18 illustrates a flowchart for practicing an alternative method 300 of the present invention for assembling a modular keyboard kit. In step 305, a retailer or individual obtains a modular keyboard kit. In step 310, the desired characteristics for the base member 110 are determined and the base member 110 is selected in step 315. In step 320, the desired resistance for depressing the keyboard keys 14 is determined and in step 325, the appropriate diaphragm 125 is inserted into the base member 110. Also at this time a desired diaphragm 125 color may be selected. Alternatively, the diaphragm 125 may be color-coded to reflect a specific keyboard key 14 resistance. For example, a green diaphragm 125 may result in a keyboard key resistance of 150 grams, and a yellow diaphragm 125 may produce a keyboard key 14 resistance of 200 grams.

In step 330, the characteristics of the cover member 105 is determined and in step 335 the cover member 105 is coupled to the base member 110. This embodiment of the invention may also include colored keyboard keys 14 in the modular keyboard kit. In this instance, specifically colored keyboard keys 14 may be selected and inserted in the cover member 105 prior to coupling the upper and lower keyboard members 85 and 90 together. Alternatively, the modular keyboard kit may include a cover member 105 that contains the necessary keyboard keys 14.

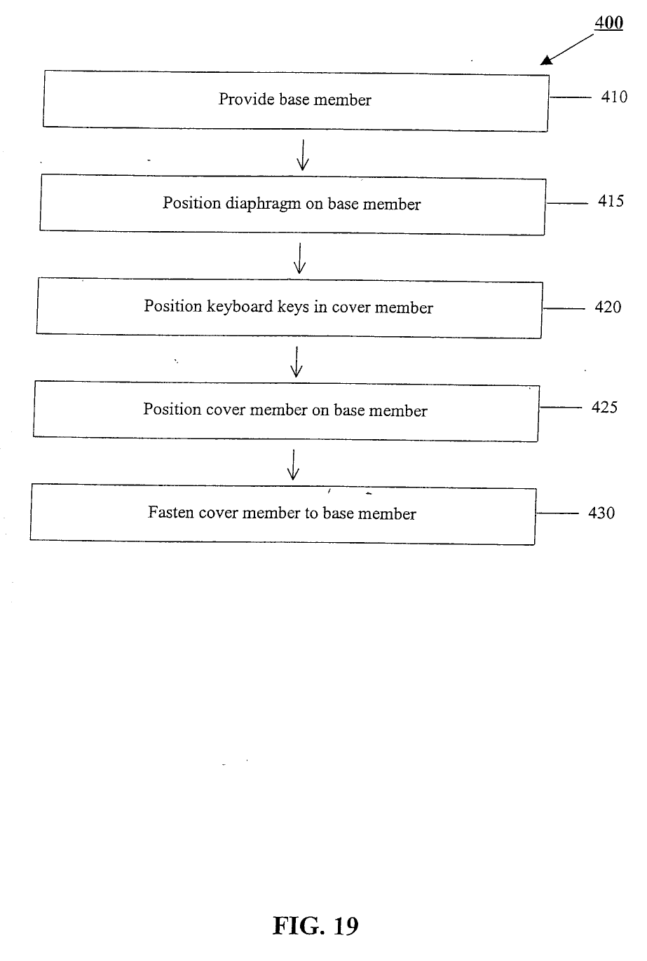

Referring to FIG. 19, an alternative method 400 of assembling a modular keyboard constructed according to the present invention is illustrated. In step 410, a base member 110 is provided. A suitable diaphragm 125 is selected and positioned within the base member 110 in step 415. In step 420, a plurality of keyboard keys 14 are selected and positioned in the cover member 105. And in step 425, the cover member 105 is placed over the base member 110. Finally, in step 430, the cover member 105 is fastened to the base member 110. Alternatively, the base member 110 can be fastened to the cover member 105.

During assembly of the present invention, differently colored keyboard members 85 or 90 may be coupled together, depending on the needs or desires of the manufacturer, retailer or individual user, any of which could assemble the keyboard 80 or 100. A diaphragm 125 may be included in the assembly process, with the diaphragm colored to match or contrast with the colors of the keyboard members 85 and 90. In addition, diaphragms 125 having different keystroke resistances may be colored differently, with each color indicating a specific keystroke resistance. Keys 14 may also be colored to match or contrast with the keyboard members 85 and 90 and/or the diaphragm 125. In addition, keys 14 marked with different languages or keys 14 that would perform specific functions may be colored differently from other keys 14. For example, a manufacturer of a computer game may provide an upper keyboard member 85 that includes keys 14 that are specifically marked or labeled to facilitate the playing of the game. Similarly, other computer software providers may provide upper keyboard members 85 with specially marked keys 14 that facilitate operation of their computer software program.

Referring to FIG. 13, another feature of the present invention is illustrated. One or more storage cavities 140 may be located in either the upper keyboard member 85 or the lower keyboard member 90. The storage cavity is configured to receive and store data storage devices, such as compact-discs (CDs), digital versatile disks (DVDs), floppy disks, memory cards of any configuration, including flash memory cards, memory tapes, and other types of data storage devices. In a preferred embodiment, several storage cavities 140 are located in the lower keyboard member 90.

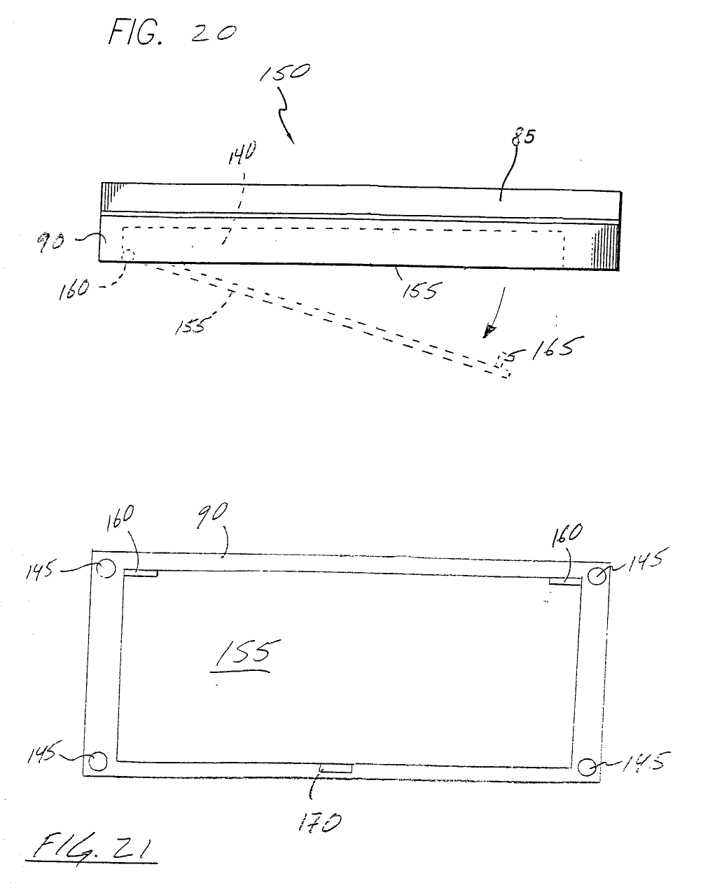

Referring to FIGS. 20-21, an alternative embodiment storage keyboard 150 is illustrated. In this embodiment the lower keyboard member 90 includes a storage cavity 140 that is accessible through the bottom of the lower keyboard member 90. This storage cavity 140 may be accessible through a door 155 that has about the same surface area as the bottom surface of the lower keyboard member 90. This would permit the storage of one or more diaphragms 125, CD's, DVD's, floppy disks, memory cards, flash cards, or other items. Alternatively, the surface area of the openable door 155 may be three-quarters, half or less than half of the surface area of the bottom of the lower keyboard member 90. The door 155 may be openable by either rotating the door away from the lower keyboard member 90 or sliding the door into the lower keyboard member 90. Illustrated in FIG. 20, the door 155 is coupled to the lower keyboard member 90 by hinge 160. One or more hinges may be used to attach the openable door 155 to the lower keyboard member 90. Preferably, storage areas are removable, such that a keyboard may be provided without a storage area, and one or more storage areas can be later attached, usually to the bottom of the keyboard. If desired, such a storage area can be replaced with a different storage area. Storage areas attached to the bottom of the keyboard should be configured to evenly support the keyboard. For example, a storage area may cover the bottom of the keyboard with an equal thickness, or two storage areas of equal thickness may be positioned under each end of the keyboard. Removable storage areas can be attached using any of a variety of fasteners, e.g., fasteners such as those used to hold upper and lower housing pieces of an openable keyboard together.

Referring to FIGS. 20-21, the door 155 has a latch assembly 170 that includes a latch 165. The latch assembly 170 may include catches, snaps, tabs or other engaging elements to secure the door 155 to the lower keyboard member 90. Also illustrated in FIG. 21 are feet 145 positioned on the bottom of the lower keyboard member 90.

FIG. 15 illustrates the interior of the hinged keyboard 80 of FIG. 13. The interior of openable keyboard 100 is configured in a similar manner. In this view, the hinged keyboard 80 has been opened and the underside of the keys 14 mounted in the cover member 105 can be seen. Diaphragm 125 is positioned on the base member 110 and is preferably constructed so that it can be quickly and easily removed. Referring to FIG. 16, the diaphragm 125 includes a plurality of diaphragm members 130 that are arranged so that when the diaphragm 125 is inserted within the base member 110 each diaphragm member 130 is positioned underneath each key 14 located in the cover member 105. The diaphragm member 130 provides keystroke resistance when the key 14 is pressed. The diaphragm member 130 can provide the resistance either alone or in conjunction with the coil spring 22.

The diaphragm 125 can have any suitable dimension. For example, one diaphragm 125 has a thickness ranging from about 0.020 of an inch to about 0.050 of an inch and a hardness of about 20 durometer to about 50 durometer as measured on a Durometer “A” scale. The diaphragm can be manufactured by injection molding or compression molding. Other types of manufacturing methods could be employed to make the diaphragm 125. Moreover, different thickness and hardness diaphragms can also be employed such that a desired key resistance is provided. The diaphragm can be made from a variety of materials including rubber, silicon, plastic, polyurethane, polyethylene and polypropylene. In addition, it can be made of a combination of any one of these materials or other suitable materials.

Although the description of the invention has been made with respect to a user configurable keyboard, it should be appreciated that the replaceable keyboard components can be selected, and/or set, and/or changed using the apparatus and methods of the present invention by any person. For example, the selections and/or installations of components can be performed during manufacture or at a retail or distribution sites.

A keyboard 80 or 100 can be made of a variety of different colors. Either keyboard (and other embodiments of the present invention) can be colored to suit the environment or to suit the design requirements of the owner. For example, a computer housing may be purple and therefore a purple keyboard may be desired. The available keyboard colors can be in any color in the visible spectrum, such as between red and violet in the visible spectrum.

The keys 14 slidably mounted in either the hinged keyboard 80 or the openable keyboard 100 can be marked with English characters or with the characters of other languages, such as Spanish, French, Russian, or German, among others.

One advantage of the present invention embodied in the hinged keyboard 80 and the openable keyboard 100 is that a user can change the keystroke resistance quickly and easily. For example, if one individual configures the hinged keyboard 80 for a lower keystroke resistance, a new user can open the hinged keyboard 80, remove the diaphragm 125 within the hinged keyboard 80, and replace it with a second diaphragm 125 having a different keystroke resistance. The hinged keyboard 80 is then closed and the operator can resume using the hinged keyboard 80. This method is not restricted to standard sized keyboards. It will be appreciated that the hinged keyboard 80 or the openable keyboard 100 of the present invention can be sized to work with portable personal digital assistants, and other portable devices that use keyboards. In addition, this invention can be employed in curved keyboards, multi-element keyboards, and other types of keyboards. Finally, the diaphragm 125 can be constructed to accommodate different keyboard designs such as those employed by IBM (IBM is a registered trademark of International Business Machines, Inc.) or APPLE (APPLE a registered trademark of Apple Computer, Inc.).

The present invention may be modified in both arrangement and detail. For example, benefits may be achieved by either increasing the keystroke resistance as indicated, increasing keystroke length as indicated, or by increasing both. Multiple springs can be used to increase the keystroke resistance of the wide space bar. The coil springs in the keyboard could be completely replaced with elastomeric springs or the increased keystroke resistance could come from a combination of the existing coil springs supplemented by elastomeric booster springs. The booster springs could also be coil or other metal type springs. A combination of base springs and booster springs, both made of suitable elastomeric material could also be used. The present invention can either be designed into the electronic keyboards themselves by OEMs or can be accomplished by using a retrofit kit consisting of individual booster springs, elastomeric templates or some other convenient way of increasing the keystroke resistance into the ranges identified, without impairing switch closure capability. Versions of the computer keyboard could be produced with higher keystroke resistance for male users and a somewhat lesser keystroke resistance for female users.

Unless otherwise defined, all technical and scientific terms used herein have the same meaning as commonly understood by one of ordinary skill in the art to which this invention belongs. All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, a variety of materials may be used to construct liquid resistant barriers, and barriers and drain channels can be configured in many different ways. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values are provided for embodiments, additional embodiments are described by taking any 2 different values as the endpoints of a range. Such ranges are also within the scope of the described invention.

Thus, additional embodiments are within the scope of the invention and within the following claims.

What is claimed is:

1. A keyboard comprising
an upper housing and a lower housing;
a plurality of keys accessible through said upper housing; and
at least one coupling that releasably attaches said upper housing and said lower housing, wherein said keyboard is an openable keyboard and said upper housing is interchangeable with one or more alternate upper housings.

2. The keyboard of claim 1, wherein said plurality of keys are mounted in said upper housing.

3. The keyboard of claim 1, wherein said coupling is selected from the group consisting of hinges, detachable hinges, tabs, clamps, latches, keys, holders, mating members, pivoting members, hooks, pins, adhesives, and hook and loop fasteners.

4. The keyboard of claim 1, wherein said upper housing is colored and is not beige, tan, gray, or black.

5. The keyboard of claim 1, wherein said upper housing is patterned.

6. The keyboard of claim 1, further comprising instructions for interchanging one or more components of said keyboard.

7. The keyboard of claim 1, wherein said keyboard is packaged together with at least 1 separate keystroke resistance setting member adapted to interchange in said keyboard.

8. The keyboard of claim 1, wherein said keyboard is configured to accept at least one storage area.

9. The keyboard of claim 1, further comprising an interchangeable liquid resistance barrier.

10. The keyboard of claim 1, wherein said keyboard is openable without requiring any tools.

11. A keyboard comprising:
an upper member and a lower member;
a plurality of keys mounted in said upper member;
a coupling configured to releasably attach said upper member and lower member; and
a plurality of resistance setting members, each resistance setting member setting a different keystroke resistance;
wherein said keyboard is an openable keyboard and each of the plurality of resistance setting members is configured to be replaceably positioned between the upper and lower members.

12. The keyboard of claim 11, wherein said resistance setting members are diaphragms.

13. The keyboard of claim 12, wherein the keystroke resistance ranges from about 70 grams to about 220 grams.

14. The keyboard of claim 11, wherein said upper member is replaceable.

15. The keyboard of claim 11, wherein at least one of the upper member and the lower member is structured to accommodate one or more data storage devices.

16. The keyboard of claim 11, wherein said coupling is selected from the group consisting of: hinges, detachable hinges, tabs, clamps, latches, keys, holders, mating members, pivoting members, hooks, and pins.

17. The keyboard of claim 12, wherein each of said diaphragms is differently colored and each said different color indicates a different keystroke resistance selection.

18. The keyboard of claim 1 1, wherein said keyboard is openable without requiring any tools.

19. A keyboard cover, comprising
a thin overlay that conforms to at least the upper surface of a computer keyboard, wherein said overlay is retained in position when installed on said keyboard, covers at least the upper surface of said keyboard, and does not cover the keys in said keyboard.

20. The keyboard cover of claim 19, wherein said cover is colored, and is not beige, tan, gray, or black.

21. The keyboard cover of claim 19, wherein said cover is textured.

22. The keyboard cover of claim 19, wherein said cover comprises a visible image.

23. The keyboard cover of claim 19, wherein said cover comprises non-English characters.

24. The keyboard cover of claim 19, wherein said cover adheres to said keyboard.

25. The keyboard cover of claim 24, wherein said cover adheres to said keyboard with a releasable adhesive.

26. The keyboard cover of claim 19, wherein said cover is clipped to said keyboard.

27. The keyboard cover of claim 19, wherein said shell is no more than 2 mm thick.

28. The keyboard cover of claim 19, wherein said shell is a film no more than 0.5 mm thick.

29. A set of replaceable computer keyboard members, comprising
a plurality of visually different replaceable keyboard upper housings adapted to fit the same pre-selected openable keyboard design.

30. The set of claim 29, wherein said plurality of visually different replaceable keyboard upper housings comprise a plurality of different colors.

31. The set of claim 29, wherein a plurality of different housings are configured for a plurality of different key configurations.

32. The set of claim 29, wherein said housings are replaceable without removal and replacement of more than two screws.

33. The set of claim 29, wherein said housings are replaceable without removal and replacement of any screws.

34. A computer keyboard modification kit, comprising
at least one replaceable keyboard upper member configured to fit an openable keyboard and at least one set of key covers.

35. The kit of claim 34, wherein said keyboard upper member and said key covers are of matching color.

36. The kit of claim 35, wherein said color is selected from the group consisting of red, pink, blue, green, turquoise, gold, and yellow.

37. The kit of claim 34, further comprising at least one keyboard lower member.

38. The kit of claim 34, wherein said key covers are assembled on keys.

39. The kit of claim 38, wherein said keys are mounted in said upper member.

40. The kit of claim 34, further comprising at least one keystroke resistance setting diaphragm.

41. The kit of claim 34, further comprising at least three keystroke resistance setting diaphragms having different keystroke resistance characteristics.

42. The kit of claim 34, further comprising at least one replaceable storage area.

43. The kit of claim 34, further comprising at least one liquid resistant barrier.

44. The kit of claim 34, further comprising instructions for modifying a keyboard using said kit.

45. A keyboard modification kit, comprising at least one replaceable keystroke resistance setting diaphragm and instructions for modifying an openable keyboard using said kit.

46. The kit of claim 45, comprising at least three keystroke resistance setting diaphragms having different keystroke resistance characteristics.

47. A keyboard kit comprising:
an openable keyboard comprising a plurality of keys mounted therein; and
a plurality of resistance setting members;
wherein each of the plurality of resistance setting members is configured to be replaceably positioned between the upper and lower members, and each resistance setting member sets a different keystroke resistance.

48. A method for changing the appearance of an openable computer keyboard, comprising
replacing a replaceable computer keyboard upper member with a replacement upper member having a different appearance.

49. The method of claim 48, further comprising replacing a plurality of keys in said keyboard with keys having different appearance.

50. The method of claim 48, further comprising replacing a keyboard lower member with a replacement lower member having a different appearance.

51. The method of claim 48, wherein said replacement upper member has a different color.

52. The method of claim 48, wherein said replacement upper member has a different visible pattern.

53. A method of adjusting a resistance of a plurality of keys mounted in an openable keyboard, comprising
opening said keyboard;
removing a first resistance setting member located within said keyboard;
installing a second resistance setting member that provides a different resistance to a motion of the keys than the first resistance setting member; and
closing said keyboard.

54. The method of claim 53, where said keyboard is a computer keyboard.

55. A method of modifying an openable keyboard, said method comprising opening said keyboard;
substituting or adding at least one replaceable keyboard component selected from the group consisting of an upper keyboard housing piece, a key set, a keystroke resistance setting diaphragm, a liquid resistant barrier, and a storage area; and
closing said keyboard.

56. The method of claim 55, wherein said keyboard is computer keyboard.
